(19) United States
(12) Patent Application Publication
(10) Pub. No.: US 2013/0191296 A1
(43) Pub. Date: Jul. 25, 2013

(54) METHOD AND SYSTEM FOR OBTAINING GHG REDUCTION CREDITS ASSOCIATED WITH GHG REDUCTION EFFORTS

(71) Applicant: Les Solutions Will (Gedden) Inc., Beloeil (CA)

(72) Inventor: Martin CLERMONT, Beloeil (CA)

(73) Assignee: Les Solutions Will (Gedden) Inc., Beloeil (CA)

(21) Appl. No.: 13/744,981

(22) Filed: Jan. 18, 2013

Related U.S. Application Data
(60) Provisional application No. 61/588,520, filed on Jan. 19, 2012.

(51) Int. Cl. G06Q 30/00; A01G 15/00

(52) U.S. Cl. CPC G06Q 30/018; A01G 15/00
USPC 705/317

(57) ABSTRACT

A method for obtaining GHG reduction credits associated with GHG reduction efforts, the method comprising grouping a plurality of sites chosen according to given GHG related parameters into a given community cluster, the GHG related parameters comprising distinct types of common potential GHG reduction efforts; profiling GHG reduction efforts provided by a corresponding site; providing an opportunity for converting the GHG reduction efforts into GHG reduction credits; upon acceptance of the opportunity for converting and performing of the GHG reduction efforts, accounting the performed GHG reduction efforts and the converted GHG reduction credits for each performing site; and returning a portion of the converted GHG reduction credits to each site. The method enables aggregating small quantities of common and generic potential GHG reduction efforts of small final emitters together to provide optimal management and monetization thereof while enabling to manage a plurality of different types of common GHG reduction efforts.

### CROSS REFERENCE TO RELATED APPLICATION

This application claims priority of U.S. Provisional Patent Application Ser. No. 61/588,520 filed on Jan. 19, 2012 and entitled “METHOD AND SYSTEM FOR OBTAINING GHG REDUCTION CREDITS ASSOCIATED WITH GHG REDUCTION EFFORTS.”

### FIELD OF THE INVENTION

This invention generally relates to the conversion of Green House Gas (GHG) reduction efforts in GHG reduction credits and more precisely pertains to a method for obtaining GHG reduction credits associated with GHG reduction efforts.

### BACKGROUND OF THE INVENTION

With increasing energy costs and growing concern about global warming, individuals and companies have become increasingly concerned with their impact on the environment and in particular their contribution to climate change.

Many GHG reduction efforts which may positively impact the environment have been identified and may be converted into financial returns such as GHG reduction credits, according to territorial regulations.

Many large final emitters are already implementing various processes to effectively reduce their impacts on the environment. The performed GHG reduction efforts are generally monitored to convert them into GHG reduction credits.

Such conversion and its procedural and financial aspects may be quite complex to manage. Automated systems for managing the conversion which are particularly adapted for large enterprises have been proposed but the management still remains complex and time consuming.

Moreover, before being monetizable into financial returns, the emission reduction efforts have to be quantified and certified by an external audit realized by a validator verificator body (VVB), according with a credible recognized protocol or standard. Then, a trading process has to be performed.

For small final emitters entities, which we can named site, such as a small enterprise, a business unit from a large enterprise (a banner), a school, commercial site or a restaurant for example, the costs of the required audits are generally prohibitive since the costs may often be much higher than the possible financial returns generated by the potential GHG reduction efforts. This may often discourage small entities to make their parts of GHG reduction efforts.

Moreover, these small entities may not be adapted to support the complex management associated to the GHG reduction effort conversion.

The legislation related to GHG reduction credits is generally specific to each of a plurality of geographical areas and jurisdictions, which may further complicate an optimal management of GHG reductions.

One GHG reduction effort that may be implemented relates to waste material exchange between a set of participants. Such exchanges may be particularly effective to reduce GHG emissions but, in some cases, may be quite complicated to manage in a most optimal manner. For example, care has to be taken to ensure that the possible financial returns are not twice accounted or just not accounted.

It would therefore be desirable to provide a method for obtaining GHG reduction credits associated with GHG reduction efforts that would reduce at least one of the above mentioned drawbacks.

### BRIEF SUMMARY

Accordingly, there is disclosed a method for obtaining GHG reduction credits associated with GHG reduction efforts, the method comprising grouping a plurality of sites chosen according to given GHG related parameters into a given community cluster, the GHG related parameters comprising at least two distinct types of common potential GHG reduction efforts; profiling with GHG related profiling data at least one of the two distinct types of site GHG reduction efforts provided by a corresponding site of the given community cluster; providing an opportunity for converting the at least one of the two distinct types of site GHG reduction efforts into GHG reduction credits according to the GHG related profiling data; upon acceptance of the opportunity for converting and performing of the at least one of the two distinct types of site GHG reduction efforts, accounting the performed site GHG reduction efforts and the converted GHG reduction credits for each performing site; and returning a portion of the converted GHG reduction credits to each site according to the respective performed site GHG reduction efforts.

The method may enable small final emitters to obtain GHG reduction credits associated with their GHG reduction efforts, which is of great advantage. Indeed, the method enables grouping and aggregating small quantities of common and generic potential GHG reduction efforts together to provide optimal management and monetization thereof while enabling to manage a plurality of different types of common GHG reduction efforts.

In one embodiment, the plurality of sites comprises small final emitters located in a regional community cluster such as for non-limitative examples, warehouses, apartment buildings, commercial buildings, hotels, restaurants, educational and institutional buildings and various other industrial and manufacturing facilities.

In a further embodiment, one of the distinct types of common potential GHG reduction efforts comprises generic energy efficiency activities and another one of the distinct types of common potential GHG reduction efforts comprises waste processing activities.

In one embodiment, at least one of the distinct types of common potential GHG reduction efforts comprises a plurality of distinct GHG reduction activities.

In a further embodiment, the GHG related parameters further comprise regional common regulations and geographical limits.

In one embodiment, the method further comprises defining general community clusters based on geographical limits and regional common regulations; and defining a plurality of specific community clusters based on specific common GHG reduction activities; wherein each site is grouped in a corresponding general community cluster and a corresponding specific community cluster.

In one embodiment, the GHG related profiling data comprise official classifications and regulations parameters.

In one embodiment, the method is used for implementing a waste materials exchange between a plurality of given sites of the given community cluster performing waste reduction efforts and a processing site performing waste processing activities.

In a further embodiment, the processing site is grouped in the given community cluster.

In one embodiment, the providing of the opportunity comprises calculating an optimal opportunity according to optimal GHG reduction credits.

In another embodiment, the providing of the opportunity comprises calculating an optimal opportunity according to optimal territory GHG reductions.

In yet another embodiment, the providing of the opportunity comprises aggregating the common potential GHG reduction efforts of the same type of each of the sites of the community cluster; and calculating an optimal opportunity for the aggregated efforts.

In still a further embodiment, the providing of the opportunity comprises calculating an optimal opportunity and at least one alternative opportunity.

In one embodiment, the providing of the opportunity comprises automatically providing the opportunity through an adapted internet-based user interface.

In a further embodiment, the providing of the opportunity comprises automatically providing the opportunity to each site of the given community cluster.

In one embodiment, the opportunity is provided by a given site of the given community cluster.

In one embodiment, the method further comprises automatically providing to each performing site their performed site GHG reduction efforts and their converted GHG reduction credits.

In one embodiment, the method further comprises providing each of the sites with internet-based profiling capabilities enabling the profiling of the site GHG reduction efforts.

In one embodiment, the method further comprises arranging a plurality of community clusters together for forming a smart network of clusters adapted to exchange GHG related information and opportunities for converting between them.

In a further embodiment, the providing of the opportunity comprises performing data mapping through the plurality of community clusters; calculating an optimal opportunity for a given common potential GHG reduction effort based on the performed data mapping; and automatically providing the calculated optimal opportunity to at least one site of a given community cluster.

In yet another embodiment, the method further comprises building a dynamic benchmark according to the performed site GHG reduction efforts and the corresponding converted GHG reduction credits in a given community cluster; building a statistical model according to the dynamic benchmark; and identifying potential errors in the profiling of the common potential GHG reduction efforts.

In one embodiment, the method further comprises providing potential opportunities to a selected group of sites of a given community cluster according to a corresponding one common potential GHG reduction effort.

According to another aspect, there is also provided a system for obtaining GHG reduction credits associated with GHG reduction efforts for a plurality of sites grouped into a given community cluster according to given GHG related parameters comprising at least two distinct types of common potential GHG reduction efforts, the system comprising a profiling unit for profiling at least one of the two distinct types of site GHG reduction efforts provided by a corresponding site of the given community cluster with GHG related profiling data; an opportunity provider coupled to the profiling unit for providing an opportunity for converting the at least one of the two distinct types of site GHG reduction efforts into GHG reduction credits according to the GHG related profiling data; an accounting unit coupled to the profiling unit and the opportunity provider for accounting the performed site GHG reduction efforts and the converted GHG reduction credits for each performing site upon acceptance of the opportunity for converting and performing of the at least one of the two distinct types of site GHG reduction efforts; and a credit returning unit coupled to the accounting unit for returning a portion of the converted GHG reduction credits to each site according to the respective performed site GHG reduction efforts.

In one embodiment, the profiling unit comprises an internet-based user interface enabling each site to profile the corresponding site GHG reduction efforts according to given GHG related profiling data.

In a further embodiment, the system further comprises a traceability unit adapted to dynamically maintain in-line electronic user accounts.

In one embodiment, the system is used for implementing a waste materials exchange between a plurality of given sites of the given community cluster performing waste reduction efforts and a processing site performing waste processing or valorisation activities.

According to another aspect, there is also provided a method of doing business in obtaining GHG reduction credits associated with GHG reduction efforts, wherein the GHG reduction credits are obtained for a fee.

According to a further aspect, there is provided a method of doing business in obtaining GHG reduction credits associated with GHG reduction efforts, the method comprising providing by a provider a system for obtaining GHG reduction credits associated with GHG reduction efforts; operating the system, wherein the operating is done by the provider; and sharing the GHG reduction credits between the provider and a corresponding user.

According to yet another aspect, there is provided a method of doing business in obtaining GHG reduction credits associated with GHG reduction efforts, the method comprising providing by a provider a system for obtaining GHG reduction credits associated with GHG reduction efforts to a third party; operating the system, wherein the operating is done by the third party for a fee; and reconveying by the third party at least a portion of the fee to the provider.

According to still another aspect, there is provided a method of doing business in using GHG reduction information for providing a potential GHG reduction opportunity, the method comprising collecting the GHG reduction information, the GHG reduction information comprising potential GHG reduction efforts and associated GHG reduction credits for a plurality of sites grouped into a given community cluster according to given GHG related parameters comprising at least one type of common potential GHG reduction efforts; aggregating the GHG reduction information related to a corresponding type of common potential GHG reduction efforts to provide aggregated GHG reduction information; using the aggregated GHG reduction information for generating a potential opportunity for converting potential GHG reduction efforts of another plurality of sites grouped into another community cluster defined according to the at least one type of common potential GHG reduction efforts; and providing the potential opportunity to at least one specific site.

### BRIEF DESCRIPTION OF THE DRAWINGS

In order that the invention may be readily understood, embodiments of the invention are illustrated by way of example in the accompanying drawings.

FIG. 1 is a flow chart of a method for obtaining GHG reduction credits associated with GHG reduction efforts, according to one embodiment.

FIG. 2 is a diagram of a computing system for obtaining GHG reduction credits associated with GHG reduction efforts, according to one embodiment.

FIG. 3 is a schematic diagram of a system for obtaining GHG reduction credits associated with GHG reduction efforts, according to one embodiment.

Further details of the invention and its advantages will be apparent from the detailed description included below.

### DETAILED DESCRIPTION

In the following description of the embodiments, references to the accompanying drawings are by way of illustration of examples by which the invention may be practiced. It will be understood that other embodiments may be made without departing from the scope of the invention disclosed.

There is disclosed a method for obtaining GHG reduction credits associated with GHG reduction efforts. As it would become apparent below, the method may be particularly useful for enabling small final emitters to obtain GHG reduction credits, i.e. money, associated with their GHG reduction efforts.

As detailed below, the method may be implemented by a third party through a cooperative effort between participants to improve both the reduction of GHG emissions on a given territory and the enhancement of financial returns for the participants, which is of great advantage.

As it will become apparent upon reading of the present description, the disclosed method enables grouping and aggregating small quantities of common and generic potential GHG reduction efforts of the same type together to provide optimal management and monetization thereof while enabling to manage a plurality of different types of common and generic GHG reduction efforts.

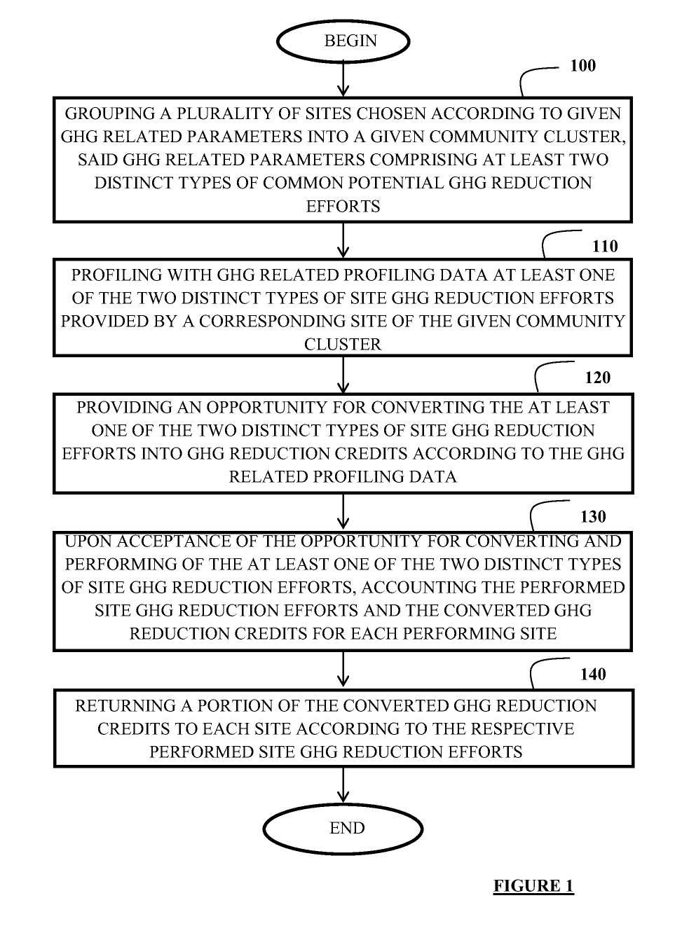

Referring to FIG. 1, there is shown a flow chart of a method for obtaining GHG reduction credits associated with GHG reduction efforts, according to one embodiment. The GHG reduction efforts may be of many types, as further detailed below, but are nevertheless chosen to be common and generic to a plurality of sites.

According to processing step 100, a plurality of sites chosen according to given GHG related parameters are grouped together into a given community cluster. The GHG related parameters comprise at least two distinct types of common potential GHG reduction efforts, as further detailed below. In one embodiment, as it should become apparent upon reading of the present description, at least one of the distinct types of common potential GHG reduction efforts may be declined in a plurality of different and distinct GHG reduction activities.

According to processing step 110, at least one of the two distinct types of site GHG reduction efforts provided by a corresponding site of the given community cluster is profiled with GHG related profiling data. The profiling data, which, in one embodiment, comprises parameters describing the GHG reduction efforts according to official classifications and regulations parameters, may help improving the management of the GHG reduction efforts, as described below.

According to processing step 120, an opportunity for converting the at least one of the two distinct types of site GHG reduction efforts into GHG reduction credits is provided, according to the GHG related profiling data. As detailed thereinafter, in one embodiment, the opportunity may be calculated according to chosen optimal parameters related to effective territory GHG reduction and/or effective financial receipts. In theses cases, an optimal opportunity is respectively calculated according to optimal GHG reduction credits and optimal territory GHG reductions. The calculated opportunity may, in one embodiment, be automatically provided to the corresponding site, for example through an adapted internet-based user interface of a “software as a service” (SaaS) system implementing the present method and enabling managing the opportunities for converting. In a further embodiment, the method is implemented through an Information and Communication Technology tracking platform.

According to processing step 130, upon acceptance of the opportunity for converting and performing of the at least one of the two distinct types of site GHG reduction efforts, the performed site GHG reduction efforts and the converted GHG reduction credits are accounted for each performing site.

According to processing step 140, a portion of the converted GHG reduction credits is returned (in cash) to each site according to the respective performed site GHG reduction efforts.

As previously mentioned, the community cluster may group a multitude of sites together. The sites may belong to a single owner or to a multitude of different and independent owners. Advantageously, the sites are not required to be equipped with a specific or common Enterprise Resource Planning (ERP) application. In one embodiment, a community cluster is defined according to geographical and territorial parameters since, generally, legal regulations are specific to a defined jurisdiction or sub-jurisdiction. In this case, the GHG related parameters further comprise regional common regulations and geographical limits.

In a further embodiment, a general community cluster based on geographical limits and regional common regulations may be defined. A plurality of specific community clusters or sub-clusters based on specific common GHG reduction activities may also be defined and each site is grouped in a corresponding general community cluster and a corresponding specific community cluster according to the type of common potential GHG reduction efforts that may be performed by the sites of the sub-cluster.

In one embodiment, the sites are small final emitters such as for non-limitative examples, warehouses, apartment buildings, commercial buildings, hotels, restaurants, educational and institutional buildings and various other industrial and manufacturing facilities located in a regional community cluster.

In one embodiment, the regional community cluster is an homogenous territory wherein the regional conditions (i.e. electricity sources, climate, waste processing schemes, etc.) and regulations (i.e. waste and emission regulations, etc.) are similar for the different facilities, and wherein homogeneous emission factors for fossil combustibles and identifiable emission factor for the electricity grid can be applied.

In a further embodiment, the sites of the cluster are chosen such that at least common energy efficiency activities and waste processing activities may be implemented. A community cluster may be particularly tailored according to specific needs of few users or may alternatively comprise several hundreds of sites of different nature.

The GHG reduction efforts may be performed according to various configurations. They may be performed on site, without collaboration with another site in a first example. For example, these on-site efforts may comprise improving the energetic efficiency of the site or optimizing transport, as detailed below. In a second example, the GHG reduction efforts may be performed between sites of the same community cluster. For example, a waste materials exchange wherein the waste materials of a first site may become the raw materials of a second site of the same cluster may be implemented. In a third example, the GHG reduction efforts of a site of the cluster may be implemented in collaboration with another site that is not part of the same community cluster, on the same territory or on another one. In a fourth example, sites of distinct community clusters may collaborate to implement the GHG reduction efforts.

As previously mentioned, the method may be particularly useful for small final emitters which would like to implement GHG reductions efforts and benefit from the associated financial returns but cannot afford the prohibitive costs of the certification audits and related processes.

In one embodiment, the method may be implemented by a third party operator through a cooperative effort between participants to aggregate small quantities of GHG reduction efforts of the same type together. In one embodiment, the third party operator is not a member of the community cluster and the method is implemented as a method of doing business in obtaining GHG reduction credits associated with GHG reduction efforts, wherein the GHG reduction credits are obtained for a fee, as detailed thereafter.

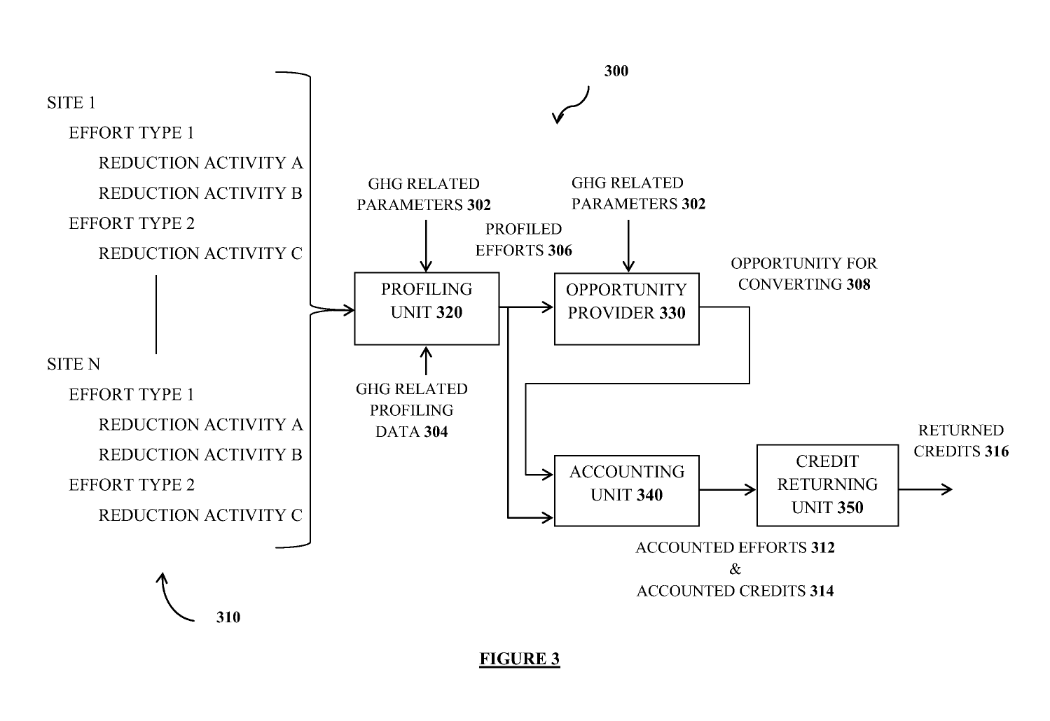

According to a further aspect and with reference to FIG. 3, there is also provided a system 300 for obtaining GHG reduction credits associated with GHG reduction efforts for a plurality of sites grouped into a given community cluster 310 according to given GHG related parameters 302 comprising at least two distinct types of common potential GHG reduction efforts.

In the illustrated embodiment, the system 300 comprises a profiling unit 320 for profiling at least one of the two distinct types of site GHG reduction efforts provided by a corresponding site of the given community cluster 310 with GHG related profiling data 304. The profiling unit 320 provides profiled efforts 306. In a further embodiment, each potential GHG reduction activity of any type may be profiled with suitable GHG related profiling data 304, as it should become apparent upon reading of the present description.

In one embodiment, the profiling unit 320 comprises an internet-based user interface (not shown) enabling each site to profile the corresponding site GHG reduction efforts according to given GHG related profiling data 304. The internet-based user interface may be implemented through a “software as a service” (SaaS) system although other arrangements may be used, as detailed therein.

The system 300 also comprises an opportunity provider 330 coupled to the profiling unit 320 and receiving the profiled efforts 306. The opportunity provider 330 provides an opportunity 308 for converting the at least one of the two distinct types of site GHG reduction efforts into GHG reduction credits according to the GHG related profiling data 304.

The system 300 also comprises an accounting unit 340 coupled to the profiling unit 320 and the opportunity provider 330 for accounting the performed site GHG reduction efforts 312 and the converted GHG reduction credits 314 for each performing site upon acceptance of the opportunity for converting and the performing of the at least one of the two distinct types of site GHG reduction efforts.

As it should become apparent to the skilled addressee, potential GHG reduction efforts may be identified but not yet performed for various reasons. For example, an opportunity for converting may not be readily available yet. The accounting unit 340 enables to accurately account the efforts 312 that have really been performed while the system 300 still enables managing the GHG reduction efforts that have been identified but not yet converted.

The system 300 also comprises a credit returning unit 350 coupled to the accounting unit 340 for returning a portion of the converted GHG reduction credits 316 to each site according to the respective performed site GHG reduction efforts.

As previously mentioned, in one embodiment, the method may be implemented through a “software as a service” (SaaS) system which enables the site to profile its own GHG reduction efforts according to given GHG related profiling data. In one embodiment, the GHG related profiling data are detailed enough and predetermined to enable an optimal conversion of the efforts into financial returns, as it should be apparent to the skilled addressee.

In one embodiment, the SaaS system comprises an opportunities calculator unit for calculating an opportunity for converting the efforts into credits according to specific parameters, as detailed therein. A plurality of distinct opportunities based on distinct parameters may also be provided for a single reduction effort. For example, an optimal opportunity may be provided along with additional alternative opportunities.

In a further embodiment, the SaaS system comprises a traceability platform adapted to dynamically maintain in-line electronic user accounts. In yet a further embodiment, the traceability platform may enable each participating site to profile each of a plurality of types of potential GHG reduction efforts. The traceability platform may further provide each participating site with in-line monitoring and managing capabilities. Accounting of the performed site GHG reduction efforts and of the converted GHG reduction credits may be provided to the participating site in an automatic manner. In-line transaction capabilities may also enable a participating site to propose an opportunity for converting to another known participating site, belonging to the same community cluster or not. This may be of great advantage in given applications, for example in a waste exchange transaction wherein the waste materials of a first site may become the raw materials of a second site, and wherein detailed and known profiling data of the waste materials may be of great importance to enable the transaction.

In the case where the method is implemented through a corresponding system operated by a third party operator, such third party operator may further provide all services related to the effective conversion of reduction efforts into financial returns such as, as non-limitative examples, the baseline scenario audits, efforts monitoring and certification, third party external audits and also the providing of the opportunities as well as the trading of the financial credits. In one embodiment, a broker may be used to trade the GHG reduction credits on the market.

In a further embodiment, the common GHG reduction efforts of the same type of a plurality of the sites of the community cluster may be aggregated before providing an opportunity for the aggregated efforts. A corresponding portion of the obtained money is returned to each site involved in the transaction while the other portion is given to the third party operator as operation costs. This is of great advantage since aggregation of small efforts of small final emitters may enable to monetize them more easily on the market through an optimal opportunity. Moreover, since the third party operator may take care of all related services such as the certification process for a corresponding fee, conversion of the reduction efforts into reduction credits may be greatly simplify for the participating sites. The skilled addressee will appreciate that grouping the sites according to common and generic potential GHG reduction efforts may help the third party operator to optimize the certification costs and all related costs.

In one embodiment, each site is rewarded according to its own individual measured efforts although other arrangements may be considered.

As previously mentioned, in one embodiment, the sites of the cluster are chosen such that at least common energy efficiency activities and waste processing activities may be implemented. Energy efficiency activities may comprise any conscious efforts enabling to reduce energy consumption, which may contribute directly or indirectly to GHG emission, of the site (for the same service or product and according to applicable admission criteria, as it should become apparent to the skilled addressee). Waste processing activities may comprises any kind of efforts enabling to generally reduce, reuse or recycle waste materials instead of sending it to landfill sites. Such waste processing activities may comprise on-site reduction, on-site reuse and on-site recycling. They may also comprise waste materials exchange between sites for reuse or recycling purposes as well as for energy transformation. In this case, the method is adapted to ensure that the GHG reduction efforts are not twice accounted, which is of great advantage.

Many other types of GHG reduction efforts may also be managed with the present method. For example, optimisation of transport, i.e. reduction of kilometers per metric ton of a product or per transported human may be implemented in the case the vehicles involved use fossil energy, as it should become apparent to the skilled addressee. Other types of GHG reduction efforts related to methane capture, optimisation of solvent use, treatment of waste water, optimization of the used of low carbon footprint of goods and services, and optimisation of residual sludge use for non-limitative examples may also be managed. Use of chlorofluorocarbon (CFC) or other common refrigerant fluids may also be optimized or reduced or even replaced with less polluting fluids. Other types of efforts which may be associated to a conscious and voluntary action and that may be optimally monetised by aggregation of small quantities of efforts may also be managed, which is of great advantage to encourage any GHG emission reduction that may be possible.

In one embodiment, the community clusters are formed according to specific parameters such as regional common regulations to ease management of such regulations. The GHG reduction efforts of a site are aggregated and accounted in the specific site community cluster but the opportunity for converting the reduction efforts into financial return may come from the same community cluster or another community cluster. Once the GHG reduction efforts provided by each site have been conveniently profiled with suitable GHG related profiling data, their monetization in another site supporting other regulation rules may be performed, which is of great advantage.

In a further embodiment, a plurality of community clusters may be arranged together to form a smart network of clusters adapted to exchange various GHG related information and opportunities for converting between them. In other words, each participating site may be grouped with other participating sites in a given cluster according to common interests.

In a further embodiment, the smart network may be adapted to perform data mapping through the plurality of community clusters in order to automatically provide an optimal opportunity to an effort. The data mapping may also be used to propose new reduction effort possibilities to specific sites, based for example on historic data of another similar community cluster. The data mapping may also facilitate the updating of the regulation rules in each covered territory and the updating of each site baseline scenario which may vary in time. Double accounting of GHG reduction efforts may be more easily prevented as well as efforts leaks associated with varying territory definitions. The different baseline scenario of each site for their own territory may also be taken into consideration more easily.

As it should become apparent upon reading of the present description, the method may enable identification and materialisation of opportunities for converting GHG reduction efforts into GHG reduction credits, which is of great advantage for encouraging overall emissions reduction over a given territory. For example, waste materials of various sites which may be reused as raw materials by another site may be listed in an in-line inventory, also called a virtual market place, as potential GHG reduction efforts that may be performed. Sites, from the same cluster or not, may consult the in-line inventory and access the profiling data of the proposed waste materials in an attempt to find raw waste materials that may be suitable for their use. As it should become apparent to the skilled addressee, in this example, transportation costs of the raw materials and other environmental or financial considerations may be taken into consideration in order to implement the most optimal opportunities for each party. As another example, potential reduction efforts based on community transportation needs which require participation of another site may also be proposed in the in-line inventory to promote the execution of the proposed reduction efforts.

In the case of potential GHG reduction efforts requiring participation of another site, the identification and materialisation of opportunities may work as follows in one embodiment. The site provides profiling data of a potential GHG reduction effort that may be performed through the traceability platform described above. In one embodiment, an audit regarding the 12 to 24 last month's activities of the site is performed. In one embodiment, indirect measures of various factors enable to determine the baseline scenario of the site at an effective cost. Each of the distinct types of common and generic potential GHG reduction efforts covered by the community cluster may be quantified. In a further embodiment, as previously described, each site is responsible for its own data entry through the provided user interface.

Once the potential GHG reduction effort of a site has been identified and suitably profiled with the GHG related profiling data into the traceability platform, such effort may be proposed to other participating sites, belonging or not to the same community cluster, as an opportunity to realize GHG emissions reduction based on an aggregation of small quantities of the similar effort.

The potential opportunity of converting a GHG reduction effort into financial return may be promoted amongst other members or collaborating entities that have been previously identified. For example, large final emitters whose activities are highly polluting may buy emission credits generated by aggregation of GHG reduction efforts based on on-site energy efficiency inside a community cluster to respond to their environmental, corporate social responsibility (CSR) and legal obligations. Although it would prima facie appear easier to trade with a limited number of bigger companies instead of a large number of small final emitters, the skilled addressee will nevertheless note that a significant part of the GHG emissions is produced by these small final emitters. Consequently, these small final emitters, judiciously grouped to provide aggregated common and generic efforts, may provide a significant part of the potential GHG reduction efforts that may be performed on a given territory to obtain financial return and real GHG emission reduction.

In the case wherein the common potential reduction efforts relate to waste materials exchange between sites, participating sites may be grouped into the same community cluster while all the opportunities are made available to all participating sites. Providing these opportunities, along with the detailed profiling data, through an in-line inventory may be of great advantage in order to promote and stimulate GHG reduction efforts. Sites transforming waste materials, into energy or recycled materials for example, may be particularly interested since they may take advantage of their raw materials needs to contribute to GHG emission reduction.

Moreover, the in-line inventory may be of great interest in some cases wherein opportunities may greatly differ in time and may be available for a very limited period, such as in the waste materials managing for example. Real-time managing of the opportunities may be implemented with the present method, provided the sites update their proposed potential GHG reduction efforts accordingly.

In one embodiment, the method may be implemented without relying on direct GHG emissions measures on the sites. Indeed, use of emission factors determined for each territory or jurisdiction modulated with a statistical approach of monitoring and third party verification may enable to validate the collected emission information, including the use of margins of error related to this emission information.

In a further embodiment, a dynamic benchmark built with the whole set of collected emission information inside the same community cluster, i.e. comprising the performed site GHG baseline emissions and reduction efforts and the corresponding converted GHG reduction credits, may help building a statistical modeling useful for identifying potential errors, for example in the profiling of the common potential GHG reduction efforts. On-site validation visits may be used for helping identification of the potential errors.

In another embodiment, the collected emission information may be used, in a depersonalized manner, to provide retro feed-back information related to the potential opportunities to a selected group of sites. In one embodiment, this information may be made publicly available to each participating site of the smart network previously described. Wasted opportunities may also be highlighted in an attempt to encourage the small final emitters to still perform more GHG reduction efforts. The collected emission information may also be used to validate site performance.

As previously described, the sites of a community cluster may be grouped together according to territorial parameters as well as common potential effort parameters. Industrial, commercial and institutional sites may be grouped in a same community cluster.

In one embodiment, ships or airplanes performing international trips or national trips may be grouped into corresponding clusters for helping them aggregate and monetize their common reduction efforts. Cities and municipalities may also be grouped into a corresponding cluster to enhance financial returns generated by the citizen efforts.

As it should become apparent to the skilled addressee, in one embodiment, the method is adapted to support the environmental regulations of each homogenous territory in which the method may be implemented. This may enable a suitable identification of the baseline emission scenario of each site of a community cluster. It should also become apparent that the present method is not specifically adapted to calculate the whole carbon footprint of a site. Rather, the smart network described above enables the sites to focus on specific segments of GHG reduction efforts that may be monetizable through the smart network.

In a further embodiment, each participating site is defined according to specific site profiling data which may comprise specific regulation and obligation rules. As it should become apparent, profiling the potential efforts as well as the participants of a community may help providing an optimal opportunity for converting and an easy managing thereof. For example, the system may enable waste materials exchange between two sites of different regional clusters while taken into consideration the specificity of each sites attached to specific territorial regulations when evaluating an opportunity.

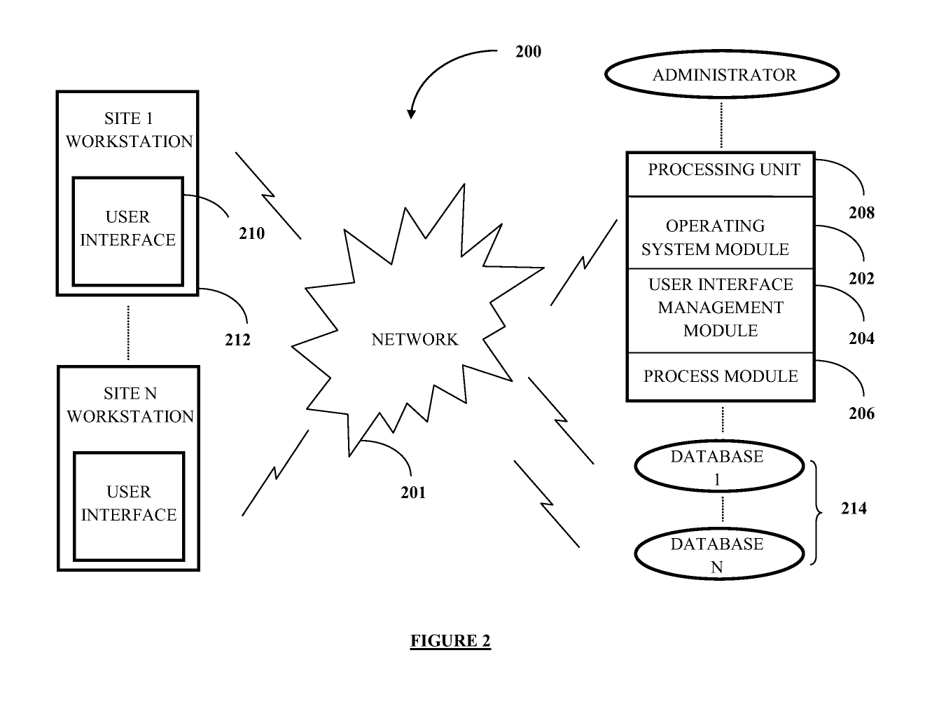

According to another aspect and with reference to FIG. 2, a computing system 200 in which an embodiment of the method for obtaining GHG reduction credits associated with GHG reduction efforts may be implemented will be described. In the illustrated embodiment, the computing system 200, which may, in one embodiment, be implemented as a “software as a service” (SaaS) system, is adapted to provide a user interface access to each participating site through the Internet 201.

In the illustrated embodiment, the computing system 200 comprises an operating system module 202, a user interface management module 204 and a process module for obtaining GHG reduction credits 206 which may be embedded and operatively connected in a processing unit 208. In one embodiment, the processing unit 208 may be embedded in a server. In a further embodiment, the process module 206 is an application running. The user interface management module 202 is used to manage the user interface of the user according to its own data.

The computing system 200 is adapted to provide to each corresponding user a user interface 210 which may be accessed through a workstation 212. The workstation 212 may be a personal computer workstation, an enterprise server, a laptop, a tablet or even a smartphone as non-limitative examples.

In one embodiment, a user will access the user interface 210 through logging to an internet site. Once suitably logged, the user may provide information related to an opportunity for converting efforts into credits. The user may also access his user interface for information purpose only, i.e. monitoring his proposed GHG reduction efforts and potential opportunities associated thereto, as well as monitoring available opportunities proposed by other users. Proposed opportunities may be accepted through the user interface 210 in one embodiment.

I/O devices, communication ports, a network interface circuit and a data bus (not shown) operatively coupled may be used for enabling a user to interact with the processing unit 208. The skilled addressee will appreciate that various embodiments of the I/O devices may be used. For example, the I/O devices may comprise at least one of a keyboard, a screen and a mouse.

The computing system 200 also comprises at least one database 214 operatively connected to the processing unit 208 for storing data related to the proposed GHG reduction efforts as well as profiling data of the users.

The processing unit 208 is adapted to manage the profiling data, calculate the optimal opportunities for converting and account the performed GHG reduction efforts and obtained GHG reduction credits.

In one embodiment, the system 200 is operated by a third party administrator although other embodiments may be considered for a given application.

As previously described, there is also provided a method of doing business in obtaining GHG reduction credits associated with GHG reduction efforts, wherein the GHG reduction credits are obtained for a fee.

In one embodiment, the method of doing business in obtaining GHG reduction credits associated with GHG reduction efforts comprises providing by a provider a system for obtaining GHG reduction credits associated with GHG reduction efforts as previously described; operating the system, wherein the operating is done by the provider; and sharing the GHG reduction credits between the provider and the corresponding user. In one embodiment, the fee may be a share of the obtained GHG reduction credits, 50% as a non-limitative example, while in an alternative embodiment, the fee may comprise fixed fees.

In a further embodiment and as described above, the provider provides all required services to the users, for example audit and certification services. These services are not charged per se to the client until the GHG reduction credits may be obtained. In one embodiment, the provider collects the GHG reduction credits. Once obtained, while a portion of these credits is returned to the corresponding site, the remaining portion is kept by the provider to operate the system and manage the required services. This embodiment may be of great advantage for small final emission providers since they are not required to support all related costs and certification procedures. Rather, they provide a portion of their obtained credits to the provider.

According to still a further aspect, a further method of doing business in obtaining GHG reduction credits associated with GHG reduction efforts is provided. In this method, a system implementing the method for obtaining GHG reduction credits associated with GHG reduction efforts is provided by a provider to a third party. The system is operated by the third party for a fee. Then, at least a portion of the fee is reconveyed by the third party to the provider.

According to yet another aspect, there is provided a method of doing business in using GHG reduction information for providing a potential GHG reduction opportunity. In this method, GHG reduction information is collected. The GHG reduction information comprises potential GHG reduction efforts and associated GHG reduction credits for a plurality of sites grouped into a given community cluster according to given GHG related parameters comprising at least one type of common potential GHG reduction efforts. The GHG reduction information related to a corresponding type of common potential GHG reduction efforts are aggregated to provide aggregated GHG reduction information. The aggregated GHG reduction information are used for generating a potential opportunity for converting potential GHG reduction efforts of another plurality of sites grouped into another community cluster defined according to the at least one type of common potential GHG reduction efforts. The potential opportunity is then provided to at least one specific site, as it should become apparent upon reading of the present description.

Although the above description relates to specific preferred embodiments as presently contemplated by the inventor, it will be understood that the invention in its broad aspect is not limited to these specific embodiments and includes mechanical and functional equivalents of the elements described herein.

What is claimed is:

1. A method for obtaining GHG reduction credits associated with GHG reduction efforts, the method comprising:
grouping a plurality of sites chosen according to given GHG related parameters into a given community cluster, said GHG related parameters comprising at least two distinct types of common potential GHG reduction efforts;
profiling with GHG related profiling data at least one of the two distinct types of site GHG reduction efforts provided by a corresponding site of the given community cluster;
providing an opportunity for converting the at least one of the two distinct types of site GHG reduction efforts into GHG reduction credits according to the GHG related profiling data;
upon acceptance of the opportunity for converting and performing of the at least one of the two distinct types of site GHG reduction efforts, accounting the performed site GHG reduction efforts and the converted GHG reduction credits for each performing site; and
returning a portion of the converted GHG reduction credits to each site according to the respective performed site GHG reduction efforts.

2. The method as claimed in claim 1, wherein the plurality of sites comprises small final emitters located in a regional community cluster.

3. The method as claimed in claim 1, wherein one of the distinct types of common potential GHG reduction efforts comprises generic energy efficiency activities and another one of the distinct types of common potential GHG reduction efforts comprises waste processing activities.

4. The method as claimed in claim 1, wherein at least one of the distinct types of common potential GHG reduction efforts comprises a plurality of distinct GHG reduction activities.

5. The method as claimed in claim 1, wherein the GHG related parameters further comprise regional common regulations and geographical limits.

6. The method as claimed in claim 1, further comprising:
defining general community clusters based on geographical limits and regional common regulations;
defining a plurality of specific community clusters based on specific common GHG reduction activities;
wherein each site is grouped in a corresponding general community cluster and a corresponding specific community cluster.

7. The method as claimed in claim 1, wherein the GHG related profiling data comprise official classifications and regulations parameters.

8. The method as claimed in claim 1 for implementing a waste materials exchange between a plurality of given sites of the given community cluster performing waste reduction efforts and a processing site performing waste processing activities.

9. The method as claimed in claim 1, wherein the providing of the opportunity comprises calculating an optimal opportunity according to optimal GHG reduction credits.

10. The method as claimed in claim 1, wherein the providing of the opportunity comprises calculating an optimal opportunity according to optimal territory GHG reductions.

11. The method as claimed in claim 1, wherein the providing of the opportunity comprises:
aggregating the common potential GHG reduction efforts of the same type of each of the sites of the community cluster; and
calculating an optimal opportunity for the aggregated efforts.

12. The method as claimed in claim 1, wherein the providing of the opportunity comprises automatically providing the opportunity through an adapted internet-based user interface.

13. The method as claimed in claim 1, wherein the opportunity is provided by a given site of the given community cluster.

14. The method as claimed in claim 1, further comprising automatically providing to each performing site their performed site GHG reduction efforts and their converted GHG reduction credits.

15. The method as claimed in claim 1, further comprising providing each of the sites with internet-based profiling capabilities enabling the profiling of the site GHG reduction efforts.

16. The method as claimed in claim 1, further comprising arranging a plurality of community clusters together for forming a smart network of clusters adapted to exchange GHG related information and opportunities for converting between them.

17. The method as claimed in claim 16, wherein the providing of the opportunity comprises:
performing data mapping through the plurality of community clusters;
calculating an optimal opportunity for a given common potential GHG reduction effort based on the performed data mapping; and
automatically providing the calculated optimal opportunity to at least one site of a given community cluster.

18. The method as claimed in claim 1, further comprising:
building a dynamic benchmark according to the performed site GHG reduction efforts and the corresponding converted GHG reduction credits in a given community cluster;
building a statistical model according to the dynamic benchmark; and
identifying potential errors in the profiling of the common potential GHG reduction efforts.

19. The method as claimed in claim 1, further comprising providing potential opportunities to a selected group of sites of a given community cluster according to a corresponding one common potential GHG reduction effort.

20. A system for obtaining GHG reduction credits associated with GHG reduction efforts for a plurality of sites grouped into a given community cluster according to given GHG related parameters comprising at least two distinct types of common potential GHG reduction efforts, the system comprising:
a profiling unit for profiling at least one of the two distinct types of site GHG reduction efforts provided by a corresponding site of the given community cluster with GHG related profiling data;
an opportunity provider coupled to the profiling unit for providing an opportunity for converting the at least one of the two distinct types of site GHG reduction efforts into GHG reduction credits according to the GHG related profiling data;
an accounting unit coupled to the profiling unit and the opportunity provider for accounting the performed site GHG reduction efforts and the converted GHG reduction credits for each performing site upon acceptance of the opportunity for converting and performing of the at least one of the two distinct types of site GHG reduction efforts; and
a credit returning unit coupled to the accounting unit for returning a portion of the converted GHG reduction credits to each site according to the respective performed site GHG reduction efforts.

21. A method of doing business in obtaining GHG reduction credits associated with GHG reduction efforts according to the method as claimed in claim 1, wherein the GHG reduction credits are obtained for a fee.

22. A method of doing business in obtaining GHG reduction credits associated with GHG reduction efforts, the method comprising:
providing by a provider a system for obtaining GHG reduction credits associated with GHG reduction efforts;
operating the system, wherein the operating is done by the provider; and
sharing the GHG reduction credits between the provider and a corresponding user.

23. A method of doing business in using GHG reduction information for providing a potential GHG reduction opportunity, the method comprising:
collecting the GHG reduction information, the GHG reduction information comprising potential GHG reduction efforts and associated GHG reduction credits for a plurality of sites grouped into a given community cluster according to given GHG related parameters comprising at least one type of common potential GHG reduction efforts;
aggregating the GHG reduction information related to a corresponding type of common potential GHG reduction efforts to provide aggregated GHG reduction information;
using the aggregated GHG reduction information for generating a potential opportunity for converting potential GHG reduction efforts of another plurality of sites grouped into another community cluster defined according to said at least one type of common potential GHG reduction efforts; and
providing the potential opportunity to at least one specific site.
